(19) United States
(12) Patent Application Publication
(10) Pub. No.: US 2008/0201432 A1
(43) Pub. Date: Aug. 21, 2008

(54) System and Method for Facilitating Transfer of Experience Data in to Generate a New Member Profile for a Online Service Portal

(75) Inventors: Mark ORTTUNG, Menlo Park, CA (US); Aaron Greco, Belmont, CA (US); Tamar Lowell, Oakland, CA (US); Patrick Newman, Palo Alto, CA (US)

Correspondence Address: GREENBERG TRAURIG, LLP (SV);IP DOCKETING, 2450 COLORADO AVENUE, SUITE 400E, SANTA MONICA, CA, 90404, US

(73) Assignee: Rearden Commerce, Inc., San Mateo, CA (US)

(21) Appl. No.: 11/625,168

(22) Filed: Feb. 16, 2007

(51) Int. Cl. G06F 15/16; G06F 3/00

(52) U.S. Cl. 709/206

(57) ABSTRACT

System and method for facilitating trasfer of experience data to generate new member profile is described. In one embodiment, the method, which can be performed on a system, comprises, in response to a user being added as a member of an online service portal, accessing from a database of the service portal, the interactions between the user and the service portal from before the user joined the service portal as a member; and, generating a member profile for the user based on the interactions between the user and the service portal from before the user joined the service portal as a member.

### BACKGROUND OF THE INVENTION

People often interact with systems even if they are not customers. For example, with an electronic services portal, various persons may be invited to attend an event and may receive an electronic notification through the system. In some cases, they may even be invited to do their booking for themselves. They may receive follow-up emails surveying attendees about the quality of the event, etc. Therefore, such people may have an activity profile in a services portal even before they become a member.

What is clearly needed is a system and method that allows a person's interaction with an electronic services portal before becoming a member to be transferred into the new account when he or she does become a member, either as an individual or as a member of an organization or enterprise.

### DESCRIPTION OF THE EMBODIMENTS

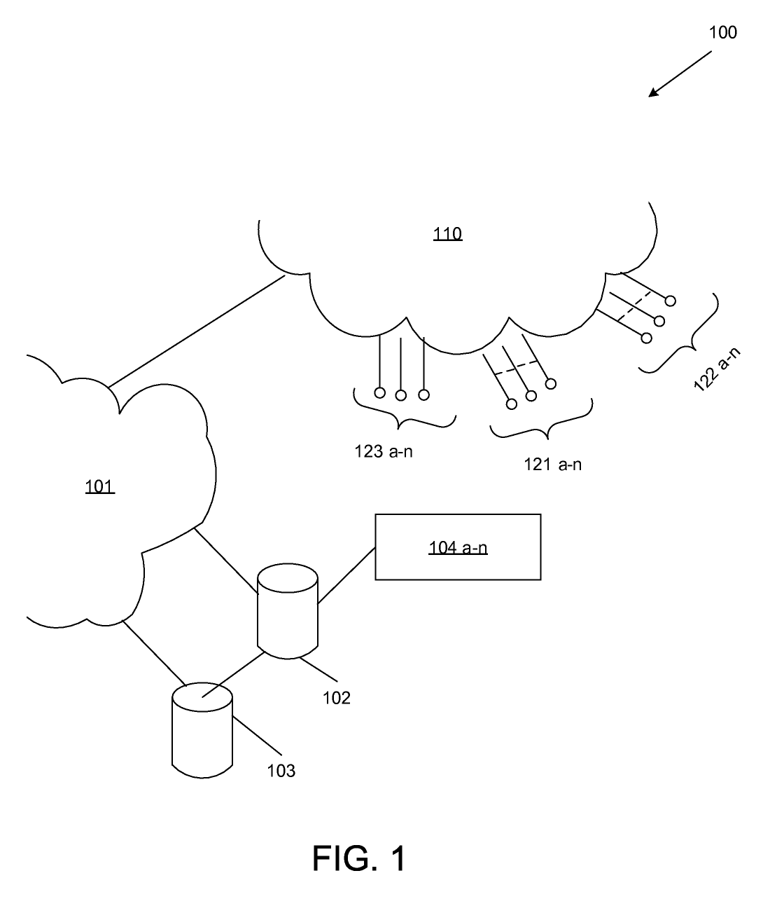

FIG. 1 shows an exemplary overview of a system 100 according to the current invention;

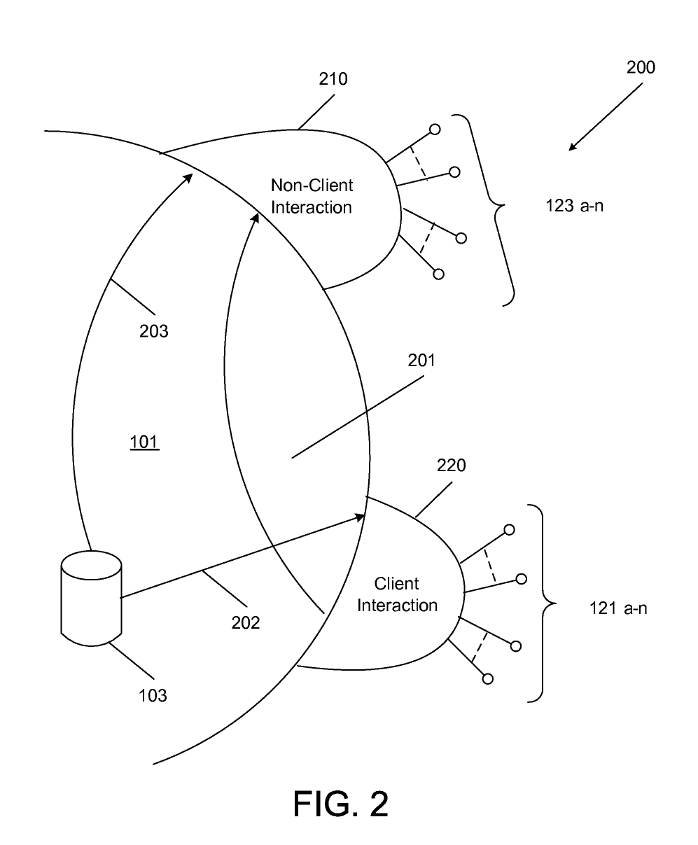

FIG. 2 shows an exemplary schematical overview 200 of nonclient interactions; and

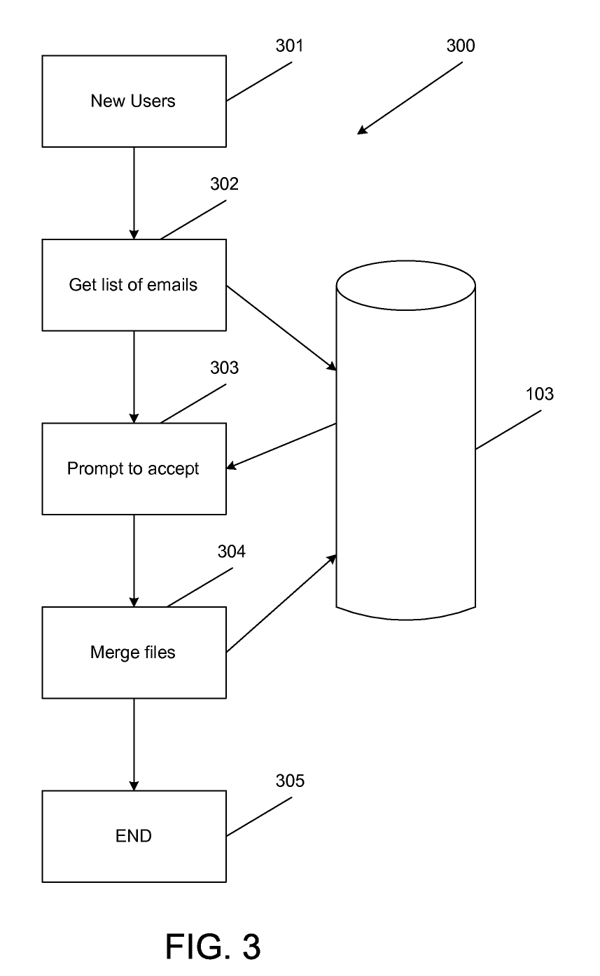

FIG. 3 shows an exemplary process 300 for implementation of the system according to one embodiment of the present invention.

### SUMMARY

System and method for facilitating transfer of experience data to generate new member profile is described. In one embodiment, the method, which can be performed on a system, comprises, in response to a user being added as a member of an online service portal, accessing from a database of the service portal, the interactions between the user and the service portal from before the user joined the service portal as a member; and generating a member profile for the user based on the interactions between the user and the service portal from before the user joined the service portal as a member.

The present disclosure includes methods and apparatuses which perform these methods, including processing systems which perform these methods, and computer readable media which when executed on processing systems cause the systems to perform these methods.

Other features of the present invention will be apparent from the accompanying drawings and from the detailed description which follows.

### DETAILED DESCRIPTION OF THE INVENTION

In the following detailed description of embodiments of the invention, reference is made to the accompanying drawings in which like references indicate similar elements, and in which is shown by way of illustration specific embodiments in which the invention may be practiced. These embodiments are described in sufficient detail to enable those skilled in the art to practice the invention, and it is to be understood that other embodiments may be utilized and that logical, mechanical, electrical, functional, and other changes may be made without departing from the scope of the present invention. The following detailed description is, therefore, not to be taken in a limiting sense, and the scope of the present invention is defined only by the appended claims.

FIG. 1 shows an exemplary overview of a system 100 according to the current invention. An electronic services portal 101 connects to a server 102 and a database 103. The server hosts several software instances 104a-n. System 101 connects via Internet 110 to system users 121a-n and suppliers 122a-n as well as non-affiliated users 123a-n. A non-affiliated user may be someone who does not have an existing business relationship with the portal, for example, but who may be invited by someone who does have a relationship to participate in an event, and therefore receives an electronic invitation to the event, either by email or by phone or both. In some cases, there may be some follow-up contact, such as a survey to check on the quality of the services provided. In yet other cases, a temporary control may be issued to a nonmember, for example, to arrange a limo pick-up for a meeting, etc. Over time, a lot of data may accrue about a non-member through these types of interactions. One important aspect of the present invention is the incorporation or transfer of this existing data into the new online persona (i.e., account) this person receives when he or she is added as a member, either as an individual or as a member of an organization or enterprise. A user is any person using the system, whether he or she has a permanent account or not, A member or client is a user who has a contractual or permanent account; a non-client user is a user that has no permanent or contractual account, but may use the system on a case-by-case basis, or with a temporary courtesy account.

FIG. 2 shows an exemplary schematical overview 200 of nonclient interactions. Two interaction bubbles, nonclient interactions 210 and client interactions 220, are contiguous to the electronic services portal 101. Each interaction has a set of users, with nonclient users 123a-n interacting through interaction 210 and client users 121a-n interacting through interaction 220. Interaction records are stored in database 103. Also shown are interaction arrows 202 and 203, as well as an invitation arrow 201. Thus a nonclient user may be allowed to use the electronic services portal to reserve a limo to meet a client user at a certain point.

FIG. 3 shows an exemplary process 300 for implementation of the system according to one embodiment of the present invention. Such a process 300 could be implemented through one of the software instances 104a-n. In process 301 a new member or user is added. In process 302 a list of previous email communications between the new member and the service portal is obtained from database 103 (the list may also include communications via other media, such as instant messaging, phone, etc.). In process 303, based on the entries extracted from database 103, the new member is prompted to accept the profiles that are his. Based on non-client use, and the related communications, a profile can be assembled, even if the non-client user does not register per se. Using communication addresses and events together, a partial profile may be collated that in fact can be quite comprehensive. As most modes of electronic communications are unique or personal (at least at a given time), these data can be used to collate a profile. In process 304, the relevant data from past communications and current data entry is merged into the member's new persona, and in process 305, the process ends.

It is clear that many modifications and variations of this embodiment may be made by one skilled in the art without departing from the spirit of the novel art of this disclosure.

The processes described above can be stored in a memory of a computer system as a set of instructions to be executed. In addition, the instructions to perform the processes described above could alternatively be stored on other forms of machine-readable media, including magnetic and optical disks. For example, the processes described could be stored on machine-readable media, such as magnetic disks or optical disks, which are accessible via a disk drive (or computer-readable medium drive). Further, the instructions can be downloaded into a computing device over a data network in a form of compiled and linked version.

Alternatively, the logic to perform the processes as discussed above could be implemented in additional computer and/or machine readable media, such as discrete hardware components as large-scale integrated circuits (LSI's), application-specific integrated circuits (ASIC's), firmware such as electrically erasable programmable read-only memory (EEPROM's); and electrical, optical, acoustical and other forms of propagated signals (e.g., carrier waves, infrared signals, digital signals, etc.).

What is claimed is:

1. A method comprising:
In response to a user being added as a member of an online service portal, accessing from a database of the service portal, the interactions between the user and the service portal from before the user joined the service portal as a member; and
Generating a member profile for the user based on the interactions between the user and the service portal from before the user joined the service portal as a member.

2. The method of claim 1, wherein the interactions comprise one or more of previous email communications, instant messaging, and telephonic communications.

3. The method of claim 2, wherein a member of the online service portal comprises a user having a membership or access rights that are not identified as temporary.

4. The method of claim 3, wherein the interactions of the user with the service portal from before the user joined the service portal as a member are generated in response to an invitation issued to the user to participate with the service portal on a temporary basis.

5. The method of claim 4, wherein the invitation is issued via one of email or telephone communications.

6. The method of claim 5, wherein the user is added as a member of the service portal, via an association with a organization or enterprise.

7. A machine readable medium having stored thereon a set of instructions which when executed, cause a machine to perform a method comprising:
In response to a user being added as a member of an online service portal, accessing from a database of the service portal, the interactions between the user and the service portal from before the user joined the service portal as a member; and
Generating a member profile for the user based on the interactions between the user and the service portal from before the user joined the service portal as a member.

8. The machine readable medium of claim 7, wherein the interactions comprise one or more of previous email communications, instant messaging, and telephonic communications.

9. The machine readable medium of claim 8, wherein a member of the online service portal comprises a user having a membership or access rights that are not identified as temporary.

10. The machine readable medium of claim 9, wherein the interactions of the user with the service portal from before the user joined the service portal as a member are generated in response to an invitation issued to the user to participate with the service portal on a temporary basis.

11. The machine readable medium of claim 10, wherein the invitation is issued via one of email or telephone communications.

12. The machine readable medium of claim 11, wherein the user is added as a member of the service portal, via an association with a organization or enterprise.

13. A system comprising:
a means for accessing from a database of the service portal, the interactions between the user and the service portal from before the user joined the service portal as a member, in response to a user being added as a member of an online service portal; and
a means for generating a member profile for the user based on the interactions between the user and the service portal from before the user joined the service portal as a member.

14. The system of claim 13, wherein the interactions comprise one or more of previous email communications, instant messaging, and telephonic communications.

15. The system of claim 14, wherein a member of the online service portal comprises a user having a membership or access rights that are not identified as temporary.

16. The system of claim 15, wherein the interactions of the user with the service portal from before the user joined the service portal as a member are generated in response to an invitation issued to the user to participate with the service portal on a temporary basis.

17. The system of claim 16, wherein the invitation is issued via one of email or telephone communications.

18. The system of claim 17, wherein the user is added as a member of the service portal, via an association with a organization or enterprise.
